(19) United States
(12) Patent Application Publication
(10) Pub. No.: US 2009/0198820 A1
(43) Pub. Date: Aug. 6, 2009

(54) PRESERVING STATE INFORMATION CLIENT-SERVER SYSTEM NETWORKED VIA A STATELESS PROTOCOL

(75) Inventors: Swapan K. Golla, Omaha, NE (US); Pohl Longsine, Lincoln, NE (US); Vishal Santoshi, Brooklyn, NY (US)

Correspondence Address: HUSCH BLACKWELL SANDERS LLP, 1620 DODGE STREET, SUITE 2100, OMAHA, NE, 68102, US

(73) Assignee: Gallup, Inc., Washington, DC (US)

(21) Appl. No.: 12/328,901

(22) Filed: Dec. 5, 2008

Related U.S. Application Data
(60) Provisional application No. 61/012,244, filed on Dec. 7, 2007.

(51) Int. Cl. G06F 15/173

(52) U.S. Cl. 709/228

(57) ABSTRACT

A method performed by a server for maintaining state in a stateless server environment is includes receiving a request for performance of an operation by an application from a client wherein the request includes a first universal resource locator (URL). A first set of state information may be extracted from the first URL, if any is present, and evaluated. A second set of state information associated with the operation is assembled, and the second set of state information contains at least the client identification information, the application information, and a counter. The counter keeps track of how many times the client has interacted with the server for the operation. The second set of state information is incorporated into a second URL.

### CROSS REFERENCE TO RELATED APPLICATION

This application is a continuation of and claims the benefit of and priority to U.S. Provisional Patent Application No. 61/012,244, filed Dec. 7, 2007, entitled PRESERVING STATE INFORMATION CLIENT-SERVER SYSTEM NETWORKED VIA A STATELESS PROTOCOL, which document is hereby incorporated by reference to the extent permitted by law.

### BACKGROUND OF THE INVENTION

1. Field of the Invention

This invention is related to computers and computer networks. In particular, the invention is related to computers preserving state while communicating over networks.

2. Description of Related Art

Network protocols provide standard methods for machines to communicate with one another. The protocols indicate how data should be formatted for receipt and transmission across networks. Heterogeneous machines can communicate seamlessly over a network via standard protocols.

A client and server may communicate either synchronously or asynchronously. In a synchronous communication, a client waits for a response from a server before issuing the next request. In an asynchronous communication, the client may issue a request to a server before one or more responses from previous requests to the server have been received.

State between a user and a machine is analogous to how a conversation between two people proceeds. Inputs from one yield outputs, or reactions from the other, and a conversation between the entities builds. This conversation, when examined as the interaction between a user and an application is a set of inputs and corresponding outputs that have led to the position that the user finds herself in.

State is used to frequently determine what to do next. For instance, in a linear application where a user is required to walk through a sequence of questions, the state of the user might be used to keep track of the current question they are answering so that the application can determine what question to ask them next. Alternatively, the state of the user might keep track of the questions, and the responses that they have been asked so far. Typically, an application will leverage the user state to provide outputs and require inputs from the user based on the context of the user that has been built up in the specific state that pertains to the user in question.

State can be maintained and worked with in a variety of ways. In a stateful system, each interaction between user and application is taken into context with all the previous interactions—quite akin to a phone conversation. As long as the communication link between the user and application is open, the state is the mutation of one continuous transaction. Interactions with a Word-Processing document, or an Interactive Voice Response (IVR) based bill payment system are typical examples of a stateful session. The application assumes complete responsibility for maintaining the current state, and mutating it as needed. The user just has to keep the transaction open for their state to remain intact. Common protocols like IVR or Hyper Text Transfer Protocol (HTTP) have to manage the concept of a user session to anything that requires more than one interaction between a client (user or machine) and server. Some protocols, like IVR are inherently stateful, while others, like HTTP are stateless. This means that every request from a client to a server is treated independently. The server has no record of previous connections. HTTP is an example of a stateless protocol. Two advantages of using stateless protocols are efficiency and simplicity. However, there are situations where it is desirable for maintaining state information during communications between the client and server. For these types of interactions, the statelessness of protocols can present problems.

As applications accessed via stateless protocols have become more sophisticated, and as the environments with which such applications interact have become more complex, it has become important to provide sophisticated support for applications accessed over stateless protocols (e.g. HyperText Transfer Protocol “HTTP”). For example, for an application available over the World Wide Web portion of the Internet (the “Web”), where the communications between browser and application are achieved via a stateless protocol, it may become important to track information including, but not limited to, who is accessing the application, services desired from the application, recent interactions with the application and likely future interactions.

Many network protocols between a client and server are stateless. This means that every request from a client to a server is treated independently. The server has no record of previous connections. HTTP is an example of a stateless protocol. Two advantages of using stateless protocols are efficiency and simplicity. However, there are situations where it is desirable for maintaining state information during communications between the client and server. For these types of interactions, the statelessness of protocols can present problems.

Conventionally, some management and tracking of applications may have been attempted through the use of “cookies” (persistent client side HTTP files). It is to be appreciated by one skilled in the art that cookies may, in addition and/or alternatively to being stored persistently in client side files, be allocated per session and/or stored in memory. Although cookies can help maintain some information, cookies cannot be relied upon to support applications accessed via stateless protocols, sessions associated with the applications, and resources associated with such applications and sessions, since users may reject cookies (e.g. for security and/or privacy reasons), and/or browsers, employed by remote clients may not support cookies. Thus, any support available via cookies is limited to the restrictions imposed by the end-user (client) which limits its use as a universal solution to session/state management over HTTP. As a user interacts with an application, the application can request that the user store an arbitrary set of key-value pairs as a result of a transaction. The cookies are parcels of text (key-value pairs) set by a server and expected as part of subsequent requests to the domain the server represents. HTTP cookies are used for authenticating, tracking, and maintaining specific information about users, such as site preferences and the contents of their electronic shopping carts. Technically, cookies are arbitrary pieces of data chosen by the Web server and sent to the browser. The client is expected to return them unchanged to the server, introducing a state (memory of previous events) into otherwise stateless HTTP transactions. Without cookies, each retrieval of a Web page or component of a Web page is an isolated event, mostly unrelated to all other views of the pages of the same site. By returning a cookie to a web server, the browser provides the server a means of connecting the current page view with prior page views. Other than being set by a web server, cookies can also be set by a script in a language such as JavaScript, if supported and enabled by the Web browser. The application expects, and the user is obligated to provide those tokens back to the application without tampering them. This is an effective mechanism, but has a number of obstacles. For one, if the user is to travel to a different machine to interact with the application, they would have lost their state and then need to reconstruct it. Additionally, if a user can not store the tokens provided, or suffers from a malicious attack that alters or steals those tokens, the user is liable for loss of data or confidentiality.

When the user of a browser selects a link on an HTML page, the browser that is displaying the page sends a request over the Internet to the server associated with the Universal Resource Locator (URL) specified in the link. In response to the request, the server transmits the requested information to the browser that issued the request. The browser receives the information, presents the received information to the user, and awaits the next user request. An easy mechanism to enable the application to overcome the weaknesses inherent to the cookie type mechanism is to encode the required tokens that the application will need directly into the available inputs that the user will be making a choice from within the results from the prior transaction. Within HTTP this concept is referred to as URL re writing. As an example, a link for a user might look like “doSomethingStateful?a=1&b=2&c=3”. Here, the application responded to the user with a possible input with embedded tokens that might have been generated/stored as a result of transactions in the past. Regardless, if the user chooses the input in question, then the application will be guaranteed to receive the tokens as listed in the example.

Cookies, as we have already noted are key-value pairs that the application (in this case, the search engine) has provided back to the client. See “Persistent Client State HTTP Cookies”, Netscape Communications Corporation, 1996, http://home.netscape.com/newsref/std/cookie.sub.--spec.html. Here, a server can satisfy an HTTP request by appending a state object known as a cookie to its response. The cookie contains a set of domains to which the data it contains is applicable. The cookie is stored by the browser running on the client. Any future HTTP requests made by the client to one of the URL's specified in the cookie will include a transmittal of the state object stored in the cookie from the client back to the server. The application expects these tokens to be returned on subsequent requests. URL re-writing covered previously too is where the user would be provided with links that contain embedded information that the application can strip out to process where the user was, relative to what they are asking for now.

This mechanism has barriers too though. Unfortunately, as the set of inputs that are needed to track state for a user grows, the overhead in shuttling them between user and application keeps increasing. Moreover, we begin to run into similar risks as we did with the cookie situation where tokens can be mutated or stolen and reused.

It is evident from the above discussion that an ongoing need exists for improved ways to preserve state while communicating over networks via stateless protocols.

### BRIEF SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The Hyper-Text-Transfer-Protocol, more commonly known as HTTP is a stateless protocol. It does have a number of mechanisms to allow for stateful applications to be built over it though. A simple use-case that embodies managing state is a search engine. A user provides a search page with a word, or set of words to search on. This input is handed to the search engine via a form executing a get or post action. The search engine scrapes the known variable name's values from the request and executes a search, providing the user with results. While this first step might have been atomic, and transactional, the search engine typically provides some form of pagination if the results are more than a fixed number in size. This is then managed via either URL re-writing, or by cookies.

The present invention opts to leverage the concept of URL re-writing to implement the session management technique described, though cookies may also be used. URL re-writing does not hinge on the client machine behaving in accordance with assumptions that the application expects to be fulfilled. Instead, the application is assured that each successive interaction will contain tokens that the application has set by mutating the possible inputs with the tokens it needs as it sends a response to the user. The session token is a unique identifier that is generated and sent from a server to a client to identify the current interaction session. The present invention allows the client to store and send the token as a part of the URL string.

By working with the discrete state changes, the mechanism is quick enough to allow for secure persistence of state, and also provide provisions for a rewinding/rollback as need be. An example of a renewing scenario is when a user chooses to use a back button on their web browser. By declaring how we treat each collected portion of data, we can follow an arbitrary set of policies on how we choose to rewind with the user. In some circumstances, we might choose to keep the very first value collected. In other scenarios, we might choose to be more intuitive and change values in state according to how they were collected or processed as the user moves backward. Either way, our maintenance of state as a collection of discrete frames of interaction allows us to reconstitute it as the user moves backwards or forwards.

This mechanism or state persistence in discrete intervals also solves a secondary issue. State reconstruction becomes fairly simple: merely assemble the frames in order. With state reconstruction being quick, clean and transactional, simple clustering may be realized as yet a third benefit. In the event of a node loss (within a cluster), state may be reconstituted on a different node using the same logic and centralized data stores.

### BRIEF DESCRIPTION OF SEVERAL VIEWS OF THE DRAWINGS

The above and/or other aspects and advantages of the present invention will become apparent and more readily appreciated from the following detailed description, taken in conjunction with the accompanying drawings of which:

FIG. 1 illustrates a schematic block diagram illustrating a system for managing state information for applications accessed over stateless protocols, in accordance with an aspect of the present invention;

FIG. 2 illustrates a schematic block diagram further illustrating a system for managing state information for applications accessed over stateless protocols, in accordance with an aspect of the present invention;

FIG. 3 illustrates data contained in a session object according to an exemplary embodiment of the present invention;

FIG. 4 illustrates an exemplary data structure in a URL string according to an exemplary embodiment of the present invention;

FIG. 5A is an exemplary communication flow between a client and a server according to an exemplary embodiment of the present invention;

FIG. 5B is an exemplary communication flow between a client and a server according to an exemplary embodiment of the present invention;

FIG. 6A is an exemplary client identification table according to an exemplary embodiment of the present invention;

FIG. 6B is an exemplary client identification table according to an exemplary embodiment of the present invention;

FIG. 6C is an exemplary client identification table according to an exemplary embodiment of the present invention;

FIG. 7 illustrates a flow chart for preserving state in a stateless server environment according to an exemplary embodiment of the present invention

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, to one skilled in the art that the present invention may be practiced without these specific details. In other instances, well-known structures and devices are shown in block diagram form in order to facilitate description of the present invention.

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a module. One or more components can reside within a process and/or thread of execution, and a module or component can be localized on one computer and/or distributed between two or more computers.

As used herein, the terms “desktop,” “PC,” “local computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like).

### GLOSSARY OF TERMS

Internet

The network of networks and gateways that use the TCP/IP suite of protocols.

TCP/IP

Transmission Control Protocol/Internet protocol. A packet switching scheme the Internet uses to chop, route, and reconstruct the data it handles, from e-mail to video.

Client

A client is a computer which issues requests or commands to the server which performs the task associated with the request or command.

State

In information processing, a state is the complete set of properties transmitted by an object to an observer via one or more channels. Any change in the nature or quantity of such properties in a state is detected by an observer and thus a transmission of information occurs.

Server

Any computer that performs a task at the command of another computer is a server. A Web server typically supports one or more clients.

Session

A session is either a lasting connection using the session layer of a network protocol or a lasting connection between a user and a server, usually involving the exchange of many packets between the user's computer and the server. A session is typically implemented as a layer in a network protocol.

World Wide Web (WWW or Web)

The Internet's application that lets people seeking information on the Internet switch from server to server and database to database by clicking on highlighted words or phrases of interest (hyperlinks). An Internet WWW server supports clients and provides information. The Web can be considered as the Internet with all of the resources addressed as URLs and which uses HTML to display the information corresponding to URLs and provide a point-and-click interface to other URLs.

Universal Resource Locator (URL)

A way to uniquely identify or address information on the Internet. Can be considered to be a Web document version of an e-mail address. URLs can be cumbersome if they belong to documents buried deep within others. They can be accessed with a Hyperlink. An example of a URL is “http://www.arun.com:80/table.html”. A URL has four components. Starting from the left, the first specifies the protocol to use, separated from the rest of the locator by a “:”. Next is the hostname or IP address of the target host; this is delimited by the “//” on the left and on the right by a “/” or optionally a “:”. The port number is optional, and is delimited on the left from the hostname by a “:” and on the right by a “/”. The fourth component is the actual file name or program name. In this example, the “.html” extension means that this is an HTML file.

Hyperlink (or Hypertext Link)

A network address embedded in a word, phrase, icon or picture that is activated when you select it. Information about that item is returned to the client and displayed using a Web browser.

HyperText Markup Language (HTML)

HTML is the language used by Web servers to create and connect documents that are viewed by Web clients. HTML uses Hypertext documents. Other uses of Hypertext documents are described in U.S. Pat. No. 5,204,947, granted Apr. 20, 1993 to Bernstein et al.; U.S. Pat. No. 5,297,249, granted Mar. 22, 1994 to Bernstein et al.; U.S. Pat. No. 5,355,472, granted Oct. 11, 1994 to Lewis; all of which are assigned to International Business Machines Corporation, and which are incorporated by reference herein.

Hypertext Transfer Protocol (HTTP)

HTTP is an example of a stateless protocol, which means that every request from a client to a server is treated independently. The server has no record of previous connections. At the beginning of a URL, “http:” indicates the file contains hyperlinks.

Web Browser

A program running on a computer that acts as an Internet tour guide, complete with pictorial desktops, directories and search tools used when a user “surfs” the Internet. In this application the Web browser is a client service which communicates with the World Wide Web.

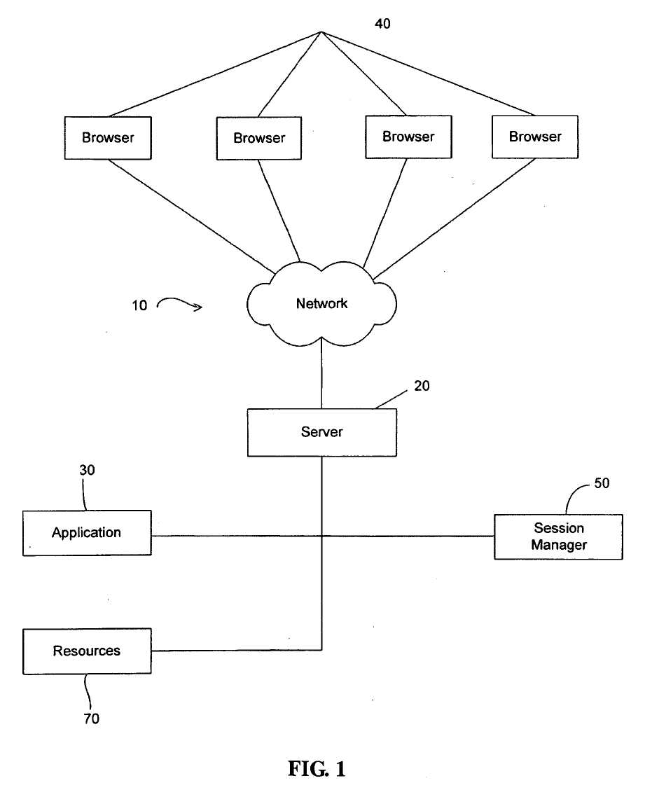

Referring initially to FIG. 1, a system 10 for managing state associated with an application 30 accessed via a stateless protocol 45 is illustrated. The application can be, for example, email, chat sessions, online shopping, video games, web-enabled applications and search engines. Although six applications are listed above, it is to be appreciated by one skilled in the art that any application for which tracking state and/or user information is beneficial may be employed with the present invention. The application 30 can be hosted by a server 20. The server 20 can be, for example, a personal computer, a workstation, and one or more distributed machines co-operating in serving the application 30. The stateless protocol can be, for example, a Hypertext Transfer Protocol (HTTP).

The application 30 may be accessed by a remote user employing a browser 40. Browser 40 may be suitable HTTP client of HTTP agent. The browser 40 and the server 20 may communicate via the stateless protocol. For example, stateless protocol requests and/or responses may travel between the browser 40 and the server 20.

One or more resources 70 may be associated with the application 30. The resources can include, but are not limited to memory, network bandwidth, processor time and communication devices. The server 20 can manage the resources 70 that are allocated to the application 30. The application 30 can be an application that can be accessed by more than one remote user. Thus, the application 30 may have resources 70 allocated for the more than one remote user.

To access an initial Web document, the user enters the URL for a Web document into a browser program. The browser 40 then sends an http request to the server 20 that has the Web document using the URL. The Web server responds to the http request by sending the requested HTTP object to the client. In most cases, the HTTP object is a plain text document containing text that is written in HyperText Markup Language (HTML). The HTML document usually contains hyperlinks to other Web documents. The browser 40 displays the HTML document on the screen for the client and the hyperlinks to other Web documents are emphasized in some fashion such that the client can select the hyperlink.

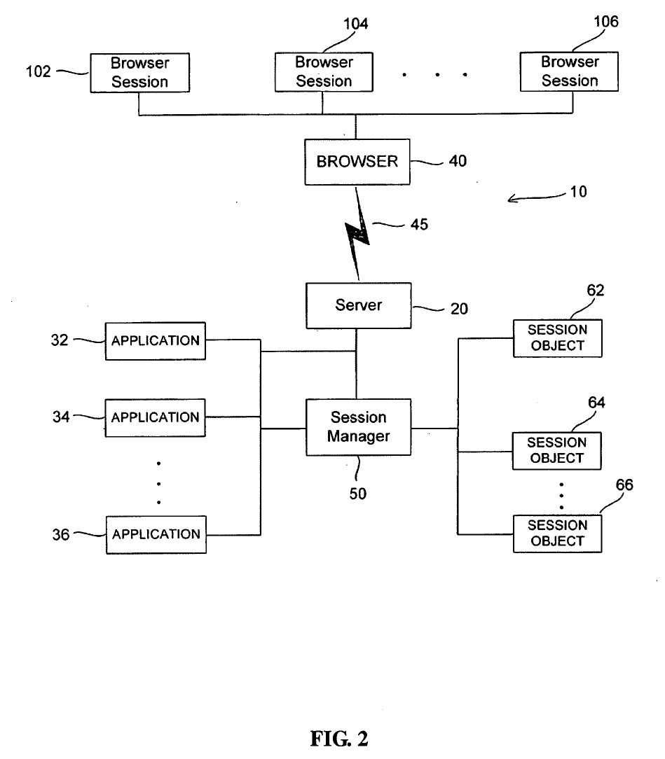

Turning now to FIG. 2, the system 10 for managing state information for the applications 32, 34, 36 accessed over the stateless protocol 45 is further illustrated. The applications 32, 34, 36 may be, for example, an email application, an electronic payment application and/or a task list application. Remote clients can access one or more applications 32, 34, 36 (collectively the applications 30) via the stateless protocol 45. Remote clients may access the applications 30 from one or more browser sessions 102, 104, 106 (collectively the sessions 100). To improve the functionality of the applications 30, the present invention facilitates creating one or more session objects 62, 64, 66 operable to contain state information about remote clients and associated sessions. One or more remote clients 42, 44, 46 (collectively the remote clients 40) access the applications 30 via the stateless protocol 45. The remote clients 42 can send requests to the applications 30 via the stateless protocol and can receive responses from the applications 30 via the stateless protocol. The requests and responses can be employed to carry information that facilitates storing state information in the one or more session objects 62, 64, 66.

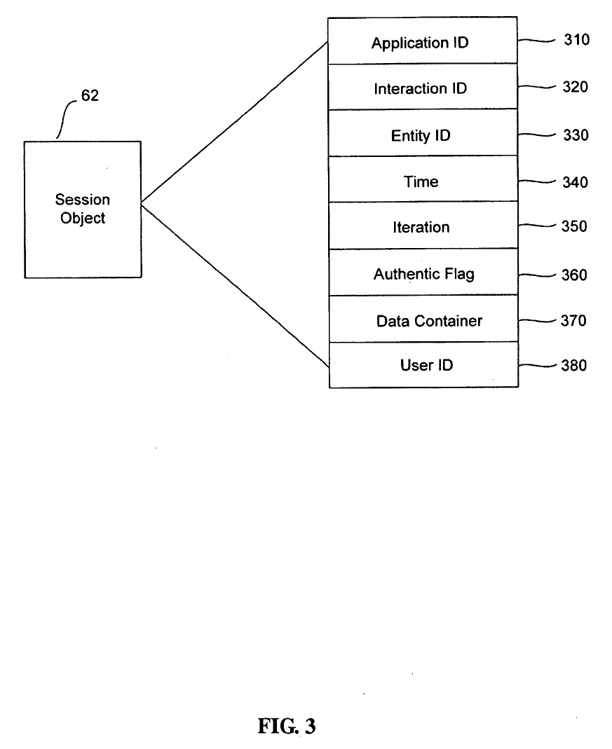

With continuing reference to FIG. 2, one or more session objects 62, 64, 66 can be created to facilitate tracking the state and user specific information employed by the applications 30. The server 20 comprises a Session Manager 50. The Session Manager 50 is a component that creates, modify or remove the session objects 62, 64, 66. Referring to FIG. 3, each session object 62, 64, 66 may contain various data including, but not limited to, (1) an Application ID 310, (2) an Interaction ID 320, (3) an Entity ID 330, (4) a Time 340, (5) an Iteration 350, (6) an Authentic flag 360, and/or (7) a Data container 370.

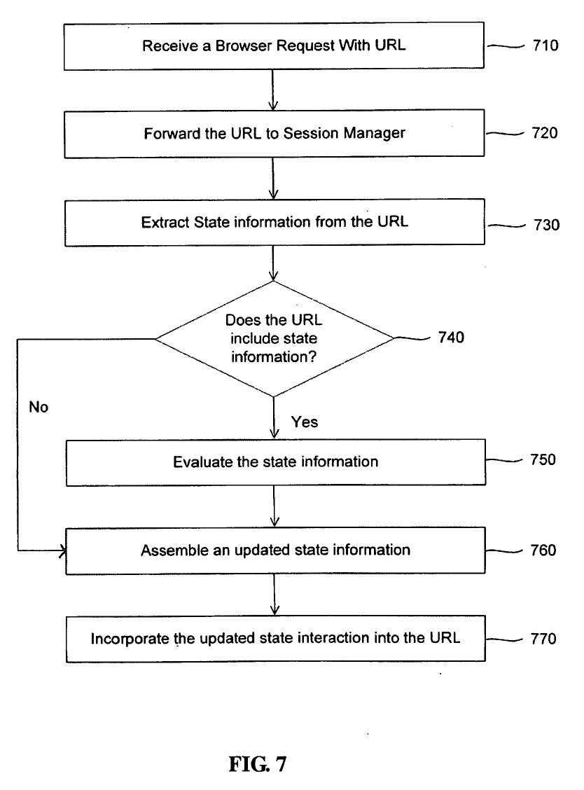

Now turning to FIG. 7, the first request for an application 30 from a client 40 will be a hit to the application 30 without any specific URL artifacts, such as: http://gx.gallup.com/app1. It only contains a “real” URL. The server 20, upon receiving the browser request (step 710), determines validity of the request according to a predetermined protocol, such as HTTP. If the hit is legal (in terms of HTTP), and is to be processed. At step 720, the application hands off the requested resource, as well as any parameters passed (in this case, an empty set) to the Session Manager 50. Upon receipt of the request, the Session Manager 50 determines if the URL for the HTTP request can be fractured to reveal any artifacts (step 740). In this instance, the artifacts within the URL include: (1) the request type: http (as opposed to hffps, or any other protocol), (2) the host (gx.gallup.com), and (3) the resource, or application requested (app1). The Session Manager 50 reconciles the supplied information to a given identifier which is referred as an Application ID 310. If the URL includes state information, the Session Manager 50 evaluates the state information (step 750).

Since there are no artifacts present that allow the Session Manager 50 to identify the client, the Session Manager 50 can conclude that the client making the request is either arriving at the application for the first time, or has not provided the application with enough information to make themselves known yet. As a result, at step 760, the Session Manager 50 creates a universally unique identifier to track the client (user ID). The Session Manager 50 checks its persistence layer for the presence of an Interaction identifier (Interaction Id) that associates a specific User ID 380 with an Application ID 310. According to one embodiment, when a browser request is received that does not contain any Interaction ID, the Session Manager 50 creates a globally unique Interaction ID 320. In further embodiment, the Interaction ID 320 includes the user ID 380 and the Application ID 310. The Session Manager 50 defines a tuple with respect to the Interaction ID 320, such as (User ID, Application ID). In this instance, the tuple includes a group including the User ID 380 and the Application ID 310.

Since the Session Manager 50 could not extract the User ID 380 for the requester, and had to create one, there will not be any Interaction that associates the freshly created User ID 380 with the Application ID 310. As a result, the Session Manager 50 creates an interaction for the client, thereby generating a universally unique Interaction ID 320. For subsequent queries to see if the given User ID 380 and Application ID 310 have an interaction, the Session Manager 50 will find that one exists, since it has just created the one above.

With Interaction ID 320, Application ID 310, and User ID 380, the Session Manager 50 then creates a fresh Session object 62, 64, 66. The Session object 62, 64, 66 stores the Time 340 that it was created. In addition, the Session object 62, 64, 66 maintains a counter named Iteration 350. Since the session has just begun, the Iteration counter 350 is initialized to 0. The Iteration 350 is a counter that keeps track of how many times the Session Manager 50 has seen the user interact with the system. It has further utility in determining state rollback and the like, covered later in Detection Mechanisms for State Rollback.

Additionally, the Session object 62, 64, 66 is initialized with an authentic flag 360 set to false. The application is responsible for managing this flag 360 by translating what the user has supplied, processing it and determining whether to keep the session authentic. For this first hit though, the session remains non-authentic.

Another thing that the Session object initializes is a Data Container 370. The Data Container 370 is a receptacle that can store arbitrary key-value pairs. The application can use the Data Container 370, via the Session object 62, 64, 66, as a place to store arbitrary data. Additionally, the Data Container 370 is to be leveraged as an intermediate space between the way in which the transport protocol in question passes parameters, and the applications execution layer. This allows specific transport protocols to manage their specific parameter extraction mechanisms and place them in the relevant Data Container 370, while still allowing the execution layer to work in a transport protocol agnostic fashion. In further embodiment, the Data Container 370 serves to allow the execution layer to place arbitrary variables and their values in a region relevant to the client and application.

At this point, the Session Manager 50 has established, created or updated a specific Session object 62, 64, 66. The created Session object 62, 64, 66 is returned by the Session Manager 50 to the application 30.

The application 30 then proceeds with whatever logical execution flow it needs to in order to respond to the client. Since it has the Session object 62, 64, 66 in hand, it has the ability to interrogate it for things like the User ID 380, or the specific time. Also, the application has the ability to store arbitrary data within the Data Container via the Session.

A necessary utility that the Session object 62, 64, 66 provides the application 30 is the ability to create hooks back to the session (links in HTTP/HTML) that reference the same session. As the application 30 processes a request, it comes up with possible resources that it deems legal for the user to see next. These could be a form including a username and password with a submit button that calls a component to authenticate a user, or a page with numerous links that allows the user to get specific areas within the application. Regardless of what the underlying logic may be, the application must demand the links to be created by the Session object by providing it with an action, command or resource that it will be able to logically process if the user chooses that link, or form.

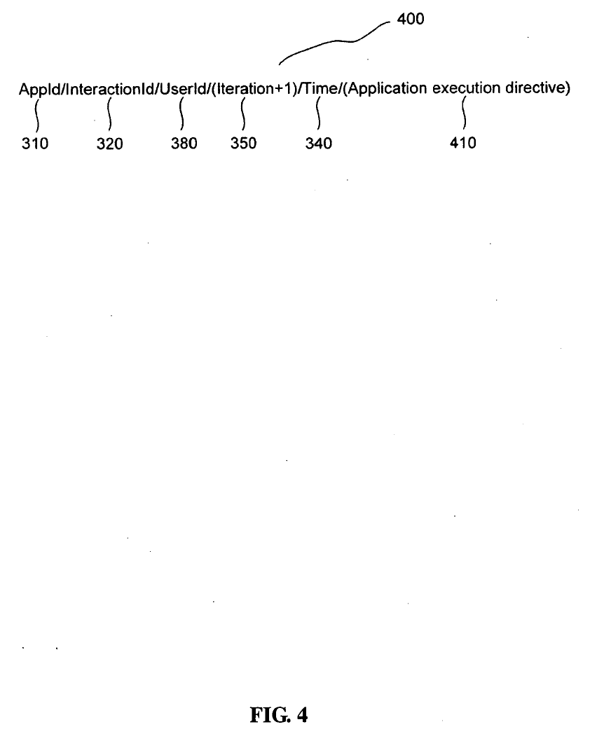

Referring now to FIGS. 1-4, the Session object 62, 64, 66 is able to accept the execution directive from the application 30 and concatenates it with artifacts that it already knows to construct a tokenized String 400. As shown in FIG. 4, the tokenized string 400 can include the Application ID 310, the Interaction ID 320, the User ID 380, the Iteration 350, the Time 340, and the execution directive 410.

The session objects 62, 64, 66 60 can be managed by a Session Manager 50 70. The Session Manager 50 70 can be responsible for actions including, but not limited to, initializing the session objects 62, 64, 66, for maintaining the session objects 62, 64, 66 and/or for reclaiming memory from session objects 62, 64, 66 that are no longer tracking state and/or user information, for example. In one example aspect of the present invention, the Session Manager 50 can monitor how long it has been since a session objects 62, 64, 66 was accessed. In the example that we have traced so far, where a user has hit the application 30 for the first time, the Session object 62, 64, 66 would have initialized the iteration 320 to zero, and so all the provided links from the Session back to the application would have the iteration augmented to one. The String 400 may then be encrypted, preferably with a quick symmetric algorithm like Blowfish. After encryption, the link is then compressed. Numerous other encryption and compression methods will be readily apparent to those of ordinary skill in the art. For example, asymmetric encryption algorithms may be used. Such alternative methods may be substituted relatively easily to conform with any desired standard.

The application execution proceeds, and when done, responds back to the user with the result. In our example so far, this would probably be a page that allows the user to authenticate, or pick some direction to start with. Only after the user has successfully provided with the response to the processing of the application 30 does the Session Manager 50 persist the contents of the Session.

The contents of the Session are persisted by iteration. The Session related artifacts that are stored include the Interaction ID 320, with the corresponding Entity ID 330 and Application ID 310.

Upon making their first request to the application 30, the Session Manager 50 has created an interaction ID 320 for the corresponding Application ID 310, and has generated a User ID 380 for the user in question. Application processing resulted in some forms/links being generated that will aid the application in identifying the user. The user is presented with a page that prompts them to enter some data and submit it.

The resource that they will be submitting to has been embedded into a link that the application had generated via the user's Session object 62, 64, 66. As a result, the link that is submitted to the application 30 is compressed, encrypted, and filled with session related artifacts.

Upon submission, the application layer 30 first extracts any HTTP specific parameters that came with the request. These might include answers to questions as form data, parameters on the URL as per how HTTP defines key-value pair submission on a URL via the GET protocol. Regardless of how they arrived, the application is responsible to harvesting them from the request. It then hands both the user submitted values as well as the user requested URL to the Session Manager 50.

The Session Manager 50 is responsible for decompressing the URL. Then, it deciphers the decompressed text. This should yield a tokenized String 400 that was actually generated by the session object 62, 64, 66 for the user on a prior request. The Session Manager 50 proceeds to extract these tokens, as shown in FIG. 4. In the event that the decompression or decryption fails, the Session Manager 50 may automatically discard the corrupted session string and start afresh.

Since the request contains an Interaction ID 320, the Application ID 310, and a User ID 380, the Session Manager 50 queries the persistence layer to ensure that an interaction ID 320 does indeed exist, and in fact correlates to the tuple consisting of the Application ID 310 and Entity ID 330. If this does exist, the Session Manager 50 assembles a Session object 62, 64, 66 based on the interaction 320.

The Session object 62, 54, 66 is reconstructed by re-assembling the Data Container 370 from what was persisted. To optimize this, the Session Manager 50 can cache the Session object 62, 64, 66 even after it has been persisted from the prior request, since there is a strong likelihood that a subsequent request will need to leverage the object anyway. Once the session has been constructed, the Session Manager 50 transfers control back to the application 30.

The application 30 is free to use the Session data to continue logical processing. At some point, the application 30 should choose to authenticate the user. The desired inputs from the user to challenge authentication will be present in the user's session, and the application 30 can harvest and logically leverage them to determine who the user is. The end result of this operation is for the application 30 to determine the actual User ID 380 for the user in question, or for the application 30 to create a new one. In the event that the application needs to create a new one, it registers the User ID 380 with the Session Manager 50.

According to one embodiment of the invention, a timeout value is associated with each transaction. The timeout value is used to identify multiple-request transactions that have not been active for a specified time period. In one embodiment, the Session Manager 50 compares the extracted time from the URL with the current time. The URL time must be less than the current time since the time on the URL was the time when the prior request was processed. The time difference therefore, is the amount of time that the user took to trigger a subsequent request. This can be very useful in helping the application logic layer determine how it wants to treat certain incoming values. If a user is only to be given 20 seconds to answer a specific question on a web page, this mechanism allows the logical layer of the application to make a decision on how to treat a time-sensitive response from the user.

Another important aspect to being able to analyze the total time taken between the current and last request allows the Session Manager 50 to determine (with parameters in the application) whether the user has “timed out.” If the duration exceeds the default, or application specific threshold, the Session Manager 50 assumes that the user will need to authenticate again. To facilitate this, the Session Manager 50 removes the authentication flag 360 from the user's session. The application 30 can then act on this and direct the user to a page that a non-authenticated user would see—quite likely a login page. Upon re-authentication, the user's session would remain intact from their prior location, and the application processing, which is dependent on the session will resume from where the user was last at.

The Session Manager 50 supports a direct request from the application layer to inactivate a particular session. Typically, this would be triggered by a user opting to log out of an application 30 that they are currently authenticated against. The mechanism proceeds in the same way as the timeout instance, setting the authentic flag 360 on the session to false so that the application 30 can no longer proceed with leveraging the contents of the session until the user has re-authenticated it.

Once the state information is assembled, the state information is incorporated into a URL. This URL, embedded within the response to the client request is returned to the requesting client. The state information may be transactionally persisted into some central data store.

When the client submits a second request relating to the same operation, the client sends the URL that was previously provided by the server which contains the state information. Upon receiving the second request, the server extracts the state information from the URL, and uses it to resume the previously initiated operation. With the benefit of this state information, the server can resume the operation at the exact point at which the previous request stopped. In the event that a user has already interacted, and authenticated against the application, their session already exists and has been persisted. If this user were to return to the application from a different location, or even return after logging out or timing out, the Session Manager 50 would initially provide them with a fresh non-authenticated session, just as it would with a first time user. Likewise, the application would challenge them, at some point, to authenticate. If the user provides a legitimate set of credentials, or tokens, that the authenticator is able to leverage successfully, then it provides the Session Manager 50 with the relevant User ID 310 and Application ID 310, derived logically from the user's input and from the executing application correspondingly.

The Session Manager 50 first checks to see if the combination of the Application ID 310 and the User ID 380 yields an existing Interaction ID 320. In the event that we are seeing the user for a second time, this is bound to be so. As such, the Session Manager 50 now has to reconcile the user's prior session, with the new session that the user has so far used to authenticate. To do this, the Session Manager 50 augments the contents of the previous session with the contents of the current session. The current temporary session is merged back onto the users' prior session. The contents of the new session's Data Container 370 are augmented to the old session in iterations that increment from where the old session left off. The Session Manager 50 leaves completes execution to have the session pegged to the original Interaction ID 320, the user's User ID 380, the application's Application ID 310, the iteration 350 of the last authenticated Session plus the iterations on the temporary new session.

The Session Manager 50 reconciles an existing session with the parameters fed to it that represent a user request. The request contains session artifacts that allow the Session Manager 50 to locate the specific session that may or may not already exist for the request in question. In the event that the request is a subsequent request for a user (any request after their first authenticated hit), the Session Manager 50 has a lot of knowledge about the user session so far. This includes the time that the last hit was made (used in determining potential timeouts), as well as the last iteration for the session.

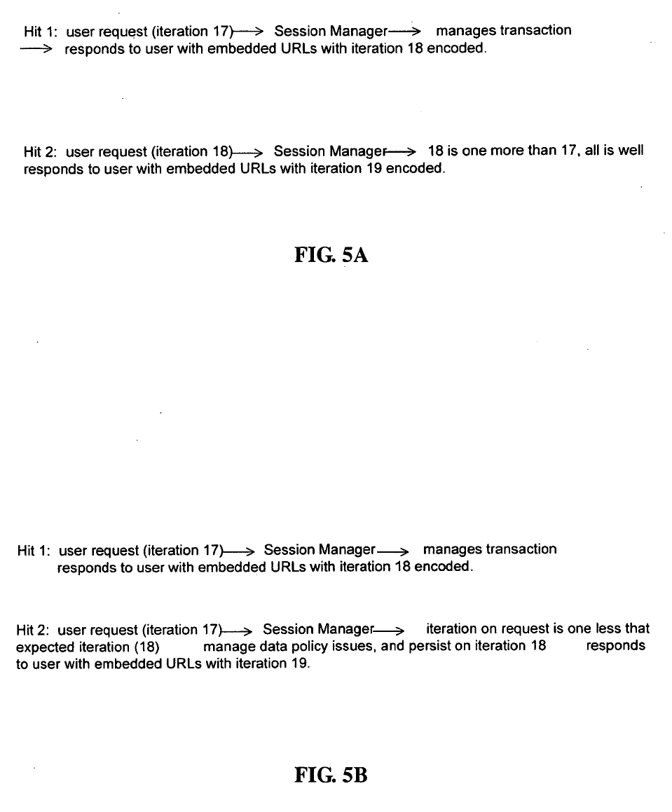

Since the Session Manager 50 knows the last iteration for a given interaction, it can know to expect a subsequent request that has an iteration incremented by one for the incoming request, as illustrated in FIG. 5A.

In the event that the Session Manager 50 gets a request with an iteration out of sequence, it knows that something is amiss, as illustrated in FIG. 5B. In the scenario shown, the Session Manager 50 was supplied a request more than once (iteration 17). This implies that one of a few things occurred as follows: (1) the user saw the response to Hit 1 (with embedded URLs pointing to iteration 18), but decided to go backward using their http client and mutate/re-submit the data on the previous page (iteration 17); or (2) the user decided to submit a transaction twice: clicked on element on page corresponding to iteration 17 embedded URLs (Hit 1) twice. As such, the Session Manager 50 gets a subsequent request with the same iteration on it (iteration 17).

When users choose to use their backward navigational abilities, the Session Manager 50 might get subsequent requests that contain iterations that are more than one increment less than the expected iteration. In these situations, the user has typically gone back more than once, bookmarked a link, or has chosen to interact with the system from two different clients.

Regardless of how the user managed to circumvent the linearity, the Session Manager's ability to detect the non-linear user behavior allows it to address the condition explicitly.

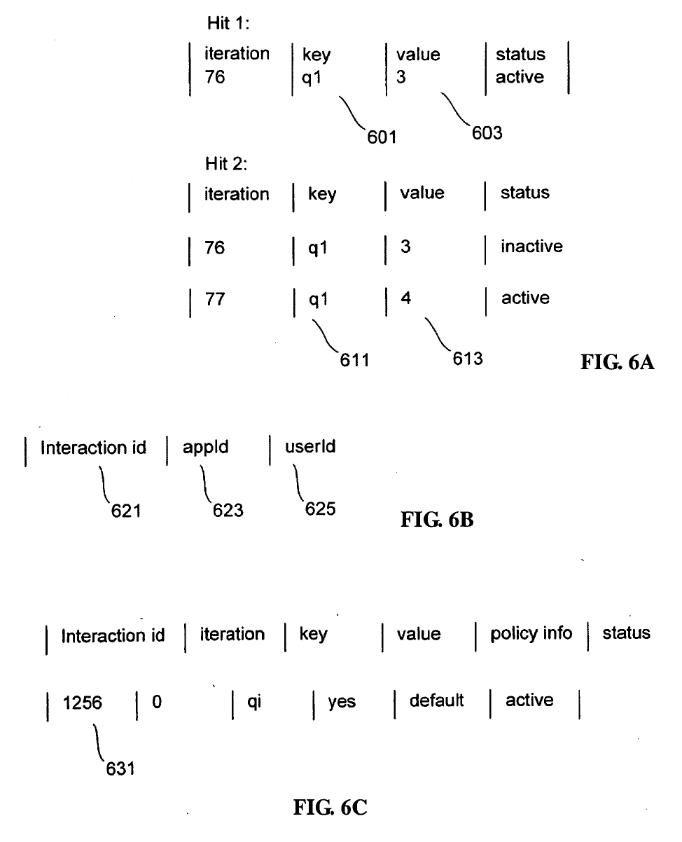

In addition to being able to detect an unexpected request as a result of an out-of-place iteration, the Session Manager 50 is able to react to this scenario. By default, keys that are re-declared or mutated by the application take precedence over keys that were declared in the past. As shown in FIG. 6A, if the application 30 were to store a variable named q1 601 with a value of 3 603 in a specific iteration, then if in a subsequent iteration, the value of q1 611 were to be changed to 4 613, then the Session Manager 50 would make the value of q1 be 4 when the application queries the session for the value of q1. This is accomplished by marking each key-value pair per iteration with a status, as illustrated in FIG. 6A. Note that the subsequent storage of q1 in the next iteration invalidates the prior occurrence of q1 and allows for the new value to be set as the one that is active 615.

However, this might not be desired all the time. In the case where an application is interested in the first value for a given variable, or chooses to declare a variable as a non-changeable (constant), this sort of mutation would not be appropriate. So, in addition to a status on each key-value pair, the Session Manager 50 also associates specific policies.

The session persistence layer is the central area where all sessions are broken down and stored. The persistence layer can be structured in many ways. However, the persistence layer needs to be able to retrieve a user session or resume on one quickly. As such, the following layout has proven effective:

### 1. Interactions

Referring to FIG. 6B, a simple table containing interaction IDs 621 with their corresponding user ID 625 and Application ID 623. Given two of the three, it is easy to determine the third. Typically, the application will have enough information to determine a user ID 625 (via authentication) and the Application ID 623 in question. This facilitates an easy discovery of the Interaction ID 621 for the session.

### 2. Responses

Referring to FIG. 6C, a table that stores the different iteration response sets. As an example, if a given userId and appId combination yields an interaction ID 631 of 1256, the data set helps break down the session into the constituent iteration frames and their constituent key-value data pairs.

Since each transaction from the user is fractured and stored into the corresponding iteration for the session, we have a mechanism available that allows us to break the entire lifespan of user interactions with the application into discrete events. Each event is tagged with the time it occurred, the command executed by the user, and all the variables that constituted the transaction. This data helps break down the session into the constituent iteration frames.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A method performed by a server for maintaining state in a stateless server environment, the method comprising the steps of:
receiving a request for performance of an operation by an application from a client wherein the request includes a first universal resource locator (URL);
extracting a first set of state information from said first URL;
evaluating said extracted first set of state information;
assembling a second set of state information associated with said operation wherein the second set of state information contains at least the client identification information, the application information, and a counter and the counter keeps track of how many times said client have interacted with said server for said operation; and
incorporating said second set of state information into a second URL.

2. The method of claim 1, wherein the second set of state information is assembled into a session object.

3. The method of claim 2, wherein the session object is configured to provide one or more links that reference a unique session.

4. The method of claim 2, wherein the session object comprises a tokenized string.

5. A computer implemented system to maintain state in a stateless server environment, the system comprising:
a server processor;
at least one application;
a session manager component for extracting state information from a universal resource locator (URL) associated with a request for performance of an operation by one of said application from a client, evaluating said extracted state information, and assembling state information associated with said operation, wherein said assembled state information contains at least the client identification information, the application information and a counter, and the counter keeps track of how many times said client have interacted with said server for said operation;
a component for encrypting said assembled state information,
wherein said encrypted state information is incorporated into the URL.

6. The system of claim 5, wherein the state information is assembled into a session object.

7. The system of claim 6, wherein the session object is configured to provide one or more links that reference a unique session.

8. The system of claim 6, wherein the session object comprises a tokenized string.
